(19) United States
(12) Patent Application Publication
(10) Pub. No.: US 2026/0023336 A1
(43) Pub. Date: Jan. 22, 2026

(54) IMAGE FORMING APPARATUS

(71) Applicant: CANON KABUSHIKI KAISHA, Tokyo (JP)

(72) Inventor: Masashi Wakisaka, Saitama (JP)

(21) Appl. No.: 19/204,880

(22) Filed: May 12, 2025

(30) Foreign Application Priority Data
Jul. 19, 2024 (JP) 2024-115586

(51) Int. Cl. G03G 15/08

(52) U.S. Cl. CPC G03G 15/0808; G03G 15/0853; G03G 15/0863; G03G 15/0868; G03G 15/0887; G03G 2215/0607

(57) ABSTRACT

There is provided an image forming apparatus including: an image bearing member; a development device configured to include a developer accommodation portion configured to accommodate a developer including a toner and a carrier; a detection portion configured to detect a toner density of the developer accommodated in the developer accommodation portion; a developer replenishment container configured to replenish the developer to the developer accommodation portion; a storage portion configured to store information specific to the toner accommodated in the developer replenishment container; a control portion configured to set a target toner density of the developer based on the information stored in the storage portion and then control the toner density of the developer accommodated in the developer accommodation portion based on a result detected by the detection portion so that the toner density of the developer accommodated in the developer accommodation portion is the target toner density of the developer.

### BACKGROUND OF THE INVENTION

### Field of the Invention

The present invention relates to an image forming apparatus such as a copying machine, a printer, or a facsimile using an electrophotographic system.

### Description of the Related Art

In an image forming apparatus using an electrophotographic system, when a latent image formed on a photosensitive drum is developed by a toner in a development device, a part of inorganic fine particles (hereinafter, referred to as an external additive) added to the toner is also developed together therewith. Since the external additive developed on the photosensitive drum has a particle diameter smaller than the particle diameter of the toner, it is difficult to remove the external additive even through a cleaning device, and the external additive may remain on the photosensitive drum.

In this case, in a case where an area in which a large amount of external additive remains on the photosensitive drum reaches the development device again, the toner is more easily developed by the electric field formed by the fine particles. As a result, in a case where a uniform image such as a halftone image is formed, a density difference may occur due to a difference in the amount of the external additive remaining on the photosensitive drum, and the image may be visually recognized as a ghost image.

Therefore, Japanese Patent Application Laid-Open No. 2019-66547 proposes a technique of rotating a photosensitive drum in a state where a development bias to be applied to a developer holder is higher than the development bias at the time of image formation and discharging an external additive in a development device onto the photosensitive drum at the time of non-image formation.

In recent years, for a toner used in an image forming apparatus using an electrophotographic system, there has been an attempt to satisfy low-temperature fixability for allowing the toner to be fixed onto a recording medium at a low temperature. However, there is a trade-off relationship between durability and stability against wear of a toner surface and the low-temperature fixability. Therefore, Japanese Patent Application Laid-Open No. 2016-139063 proposes a technique of carrying a large amount of external additives on the toner surface.

However, in a case where manufacturing conditions vary depending on a lot at the time of manufacturing the toner, the amount of the external additive carried on the toner surface may vary. For example, in a case where the amount of the external additive carried on the toner surface increases, the amount of the external additive remaining on the photosensitive drum without being cleaned off also increases, and as a result, visibility of a ghost image caused by a difference in the amount of the external additive remaining on the photosensitive drum deteriorates. On the other hand, in a case where the amount of the external additive carried on the toner surface decreases, the toner density is excessively lowered, and developability of the toner with respect to the photosensitive drum is deteriorated.

### SUMMARY OF THE INVENTION

In the present invention, it is desired to provide an image forming apparatus capable of forming a good image even in a case where the amount of the external additive carried on the toner surface varies depending on a lot at the time of manufacturing the toner.

According to a representative configuration of the present invention, there is provided an image forming apparatus including: an image bearing member; a development device configured to include a developer accommodation portion configured to accommodate a developer including a toner and a carrier, and a developer bearing member configured to carry and convey the developer, and develop an electrostatic image formed on the image bearing member using the toner; a detection portion configured to detect a toner density of the developer accommodated in the developer accommodation portion; a developer replenishment container configured to be detachably attached to the image forming apparatus, accommodate the developer including the toner having a fine particle attached to a surface of the toner, and replenish the developer to the developer accommodation portion; a storage portion configured to be provided in the developer replenishment container, and store information specific to the toner accommodated in the developer replenishment container; and a control portion configured to set a target toner density of the developer based on the information stored in the storage portion and then control the toner density of the developer accommodated in the developer accommodation portion based on a result detected by the detection portion so that the toner density of the developer accommodated in the developer accommodation portion is the target toner density of the developer.

Further features of the present invention will become apparent from the following description of exemplary embodiments with reference to the attached drawings.

### BRIEF DESCRIPTION OF THE DRAWINGS

FIG. 1 is a schematic diagram of an image forming apparatus;

FIG. 2 is a cross-sectional view of an image forming portion;

FIG. 3A is a cross-sectional view of a development device, and FIG. 3B is a top view of the development device;

FIG. 4 is a cross-sectional view illustrating transfer of an external additive between a toner and a carrier;

FIG. 5 is a perspective view of a developer replenishment container;

FIG. 6A and FIG. 6B are diagrams illustrating a ghost image;

FIG. 7 is a diagram illustrating a relationship between an external-additive coverage rate of a toner alone and an external-additive coverage rate of a developer in a development device;

FIG. 8 is a table illustrating a relationship between an external-additive coverage rate of a toner alone and an external-additive coverage rate of a toner of a developer in a development device for each toner density; and

FIG. 9 is a flowchart illustrating a toner density calculation method.

### DESCRIPTION OF THE EMBODIMENTS

Hereinafter, embodiments of the present invention will be described in detail with reference to the drawings. Note that the embodiments to be described below are exemplary embodiments of the present invention, and thus technically preferable limitations are given. However, the scope of the present invention is not limited to these embodiments unless the scope of the present invention is particularly limited in the following description.

### Example 1

### Image Forming Apparatus

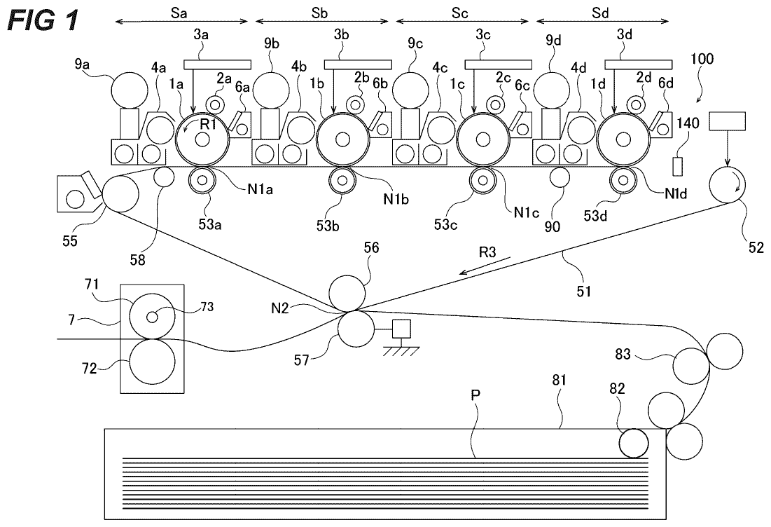

First, an overall configuration and an operation of an image forming apparatus according to the present invention will be described. FIG. 1 illustrates a schematic cross-sectional configuration of an image forming apparatus 100 according to the present example. The image forming apparatus 100 according to the present example is a full-color electrophotographic image forming apparatus including four photosensitive drums and using an intermediate transfer method. In the present example, a process speed corresponding to a surface moving velocity of a photosensitive drum 1 and an intermediate transfer belt 51 is 150 mm/sec.

The image forming apparatus 100 includes first, second, third, and fourth image forming portions (process units) Sa, Sb, Sc, and Sd as a plurality of image forming portions. Each of the image forming portions Sa, Sb, Sc, and Sd forms each color of yellow (Y), magenta (M), cyan (C), and black (Bk). In the present example, the configurations of the image forming portions Sa to Sd are substantially the same except that the colors of the toners to be used are different. Therefore, in the following description, unless a particular distinction is required, the subscripts a, b, c, and d given to the reference numerals in the drawings to indicate that the elements are provided for any one of the colors will be omitted, and the elements will be collectively described.

The image forming portion S includes a photosensitive drum 1 that is an image bearing member. In the vicinity of the photosensitive drum 1, a charging roller 2 that is a primary charging portion, a laser scanner 3 that is an exposure portion, a development device 4 that is a development portion, a drum cleaner 6 that is a drum cleaning portion, and the like are sequentially disposed along a rotation direction of the photosensitive drum 1. Further, a belt member that can circulate as an intermediate transfer member, that is, an intermediate transfer belt 51 is disposed adjacent to the photosensitive drums 1a to 1d of the image forming portions Sa to Sd.

The intermediate transfer belt 51 is stretched around a driving roller 52, a steering roller 55, a secondary transfer inner roller 56, and an upstream regulating roller 58 as a plurality of support members. The steering roller 55 also has a function of applying a tension force for tensioning the intermediate transfer belt 51. Specifically, in the steering roller 55, both ends of the steering roller 55 are energized in a substantially left direction (a direction away from the driving roller 52) in FIG. 1 by a spring energization portion (not illustrated). The driving force is transmitted to the intermediate transfer belt 51 by the driving roller 52 that is a belt driving portion, and the intermediate transfer belt 51 circulates in a direction of an arrow R3 in FIG. 1.

The primary transfer rollers 53a to 53d that are primary transfer members are disposed at positions facing the photosensitive drums 1a to 1d on an inner circumferential surface side of the intermediate transfer belt 51. Each of the primary transfer rollers 53a to 53d is energized toward each of the photosensitive drums 1a to 1d via the intermediate transfer belt 51, and primary transfer portions (primary transfer nips) N1a to N1d at which each of the photosensitive drums 1a to 1d and the intermediate transfer belt 51 are in contact with each other are formed.

Further, a secondary transfer outer roller 57 that is a secondary transfer member is disposed at a position facing the secondary transfer inner roller 56 on an outer circumferential surface side of the intermediate transfer belt 51. The secondary transfer outer roller 57 is in contact with the outer circumferential surface of the intermediate transfer belt 51 to form a secondary transfer portion (secondary transfer nip) N2.

The images on the photosensitive drums 1a to 1d that are formed by the image forming portions Sa to Sd are transferred in a sequentially superimposed manner onto the intermediate transfer belt 51 that moves and passes adjacent to the photosensitive drums 1a to 1d. Thereafter, the image transferred onto the intermediate transfer belt 51 is further transferred onto a transfer material P such as a sheet at a secondary transfer portion N2.

Note that the transfer material P such as a sheet is fed one by one from a sheet cassette 81 by a feeding roller 82, and is conveyed to a pair of registration rollers 83. The pair of registration rollers 83 stops a leading end of the transfer material P to correct skew feeding, and resumes conveyance of the transfer material P according to a progress of an image forming operation that is a toner image forming process by the image forming portion.

A fixing device 7 includes a fixing roller 71 that is rotatably disposed, and a pressure roller 72 that rotates while being in pressure contact with the fixing roller 71. A heater 73 such as a halogen lamp is disposed inside the fixing roller 71. In addition, a temperature of a surface of the fixing roller 71 is adjusted by controlling a voltage or the like to be supplied to the heater 73. In a case where the transfer material P is conveyed to the fixing device 7, when the transfer material P passes between the fixing roller 71 and the pressure roller 72 that rotate at a constant speed, the transfer material P is pressurized and heated from both front and back sides of the transfer material P at a substantially constant pressure and a substantially constant temperature. Thereby, an unfixed toner image on the surface of the transfer material P is melted and fixed onto the transfer material P. In this way, a full-color image is formed on the transfer material P.

### Image Forming Portion

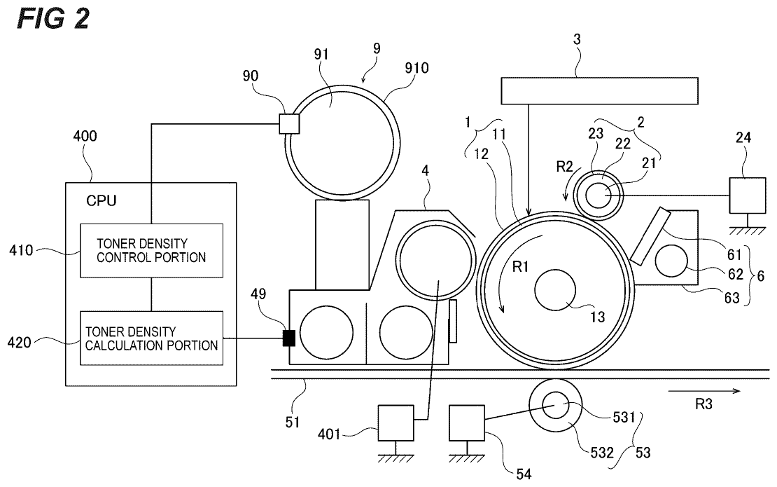

Next, details of the image forming portion S in FIG. 2 will be described. More specifically, referring to FIG. 2, the photosensitive drum 1 is rotatably supported by a main body of the image forming apparatus. The photosensitive drum 1 is a cylindrical electrophotographic photosensitive member including, as a basic configuration, a conductive base 11 made of aluminum or the like and a photoconductive layer 12 formed on an outer circumference of the conductive base 11. The photosensitive drum 1 has a support shaft 13 at the center of the photosensitive drum. The photosensitive drum 1 is rotationally driven in a direction of an arrow R1 in FIG. 2 around the support shaft 13 by a driving portion (not illustrated). Although an organic optical-semiconductor photosensitive drum having a size of φ30 is used in the present example, an amorphous silicon-based photosensitive drum may be used.

A charging roller 2 that is a primary charging portion is disposed above the photosensitive drum 1 in FIG. 2. The charging roller 2 is in contact with the surface of the photosensitive drum 1 to uniformly charge the surface of the photosensitive drum 1 to a predetermined polarity and predetermined potential. The charging roller 2 includes a conductive core metal 21 that is disposed at the center, a low-resistance conductive layer 22 that is formed on an outer circumference of the conductive core metal 21, and a medium-resistance conductive layer 23, and is formed in a roller shape as a whole. Both ends of the core metal 21 of the charging roller 2 are rotatably supported by bearing members (not illustrated), and are disposed in parallel to the photosensitive drum 1. The bearing members at both ends of the core metal 21 are energized toward the photosensitive drum 1 by a pressing portion (not illustrated). Thereby, the charging roller 2 is pressed against the surface of the photosensitive drum 1 with a predetermined pressing force. The charging roller 2 is driven to rotate in a direction of an arrow R2 in FIG. 2 according to the rotation of the photosensitive drum 1 in the direction of the arrow R1 in FIG. 2. A charging bias voltage is applied to the charging roller 2 by a charging bias power supply 24 that is a charging bias output portion. Thereby, in the present example, the surface of the photosensitive drum 1 is uniformly charged to −600 V.

A laser scanner 3 is disposed on a downstream side of the charging roller 2 in the rotation direction of the photosensitive drum 1. The laser scanner 3 performs scanning on the photosensitive drum 1 with laser beams while turning off/on the laser beams based on image information to expose the photosensitive drum 1. Thereby, an electrostatic image (latent image) according to the image information is formed on the photosensitive drum 1. The laser scanner used in the present example has a wavelength of λ=780 nm and resolution of 600 dpi.

The development device 4 is disposed on a downstream side of the laser scanner 3 in the rotation direction of the photosensitive drum 1. Details of the development device 4 that visualizes the electrostatic image formed on the photosensitive drum 1 and a toner replenishment device 9 that replenishes a toner to the development device 4 will be described later.

The primary transfer roller 53 is disposed below the photosensitive drum 1 on a downstream side of the development device 4 in the rotation direction of the photosensitive drum 1 in FIG. 2. The primary transfer roller 53 includes a core metal 531 and a conductive layer 532 formed in a cylindrical shape on an outer circumferential surface of the core metal 531. Both ends of the primary transfer roller 53 are energized toward the photosensitive drum 1 by a pressing member (not illustrated) such as a spring. Thereby, the conductive layer 532 of the primary transfer roller 53 is pressed against the surface of the photosensitive drum 1 via the intermediate transfer belt 51 with a predetermined pressing force. Further, a primary transfer bias power supply 54 that is a primary transfer bias output portion is connected to the core metal 531. The primary transfer portion N1 is formed between the photosensitive drum 1 and the primary transfer roller 53. The intermediate transfer belt 51 is sandwiched at the primary transfer portion N1. The primary transfer roller 53 contacts the inner circumferential surface of the intermediate transfer belt 51, and rotates according to the movement of the intermediate transfer belt 51. In addition, at the time of image formation, a primary transfer bias voltage having a polarity (second polarity, a positive polarity in the present example) opposite to the normal charging polarity (first polarity, a negative polarity in the present example) of the toner is applied to the primary transfer roller 53 by the primary transfer bias power supply 54. In addition, an electric field is formed between the primary transfer roller 53 and the photosensitive drum 1 in a direction in which the toner having the first polarity is moved from the photosensitive drum 1 toward the intermediate transfer belt 51. Thereby, the toner image on the photosensitive drum 1 is transferred (primarily transferred) to the surface of the intermediate transfer belt 51.

Any deposits such as the toner (primary transfer residual toner) remaining on the surface of the photosensitive drum 1 after the primary transfer step are cleaned by the drum cleaner 6. The drum cleaner 6 includes a cleaning blade 61 that is a drum cleaning member, a conveying screw 62, and a drum cleaner housing 63. The cleaning blade 61 is brought into contact with the photosensitive drum 1 at a predetermined angle and a predetermined pressure by a pressing portion (not illustrated). Thereby, the toner and the like remaining on the surface of the photosensitive drum 1 are scraped off and removed from the photosensitive drum 1 by the cleaning blade 61, and are collected into the drum cleaner housing 63. The collected toner and the like are conveyed by the conveying screw 62, and are discharged to a waste toner storage portion (not illustrated).

### Development Device

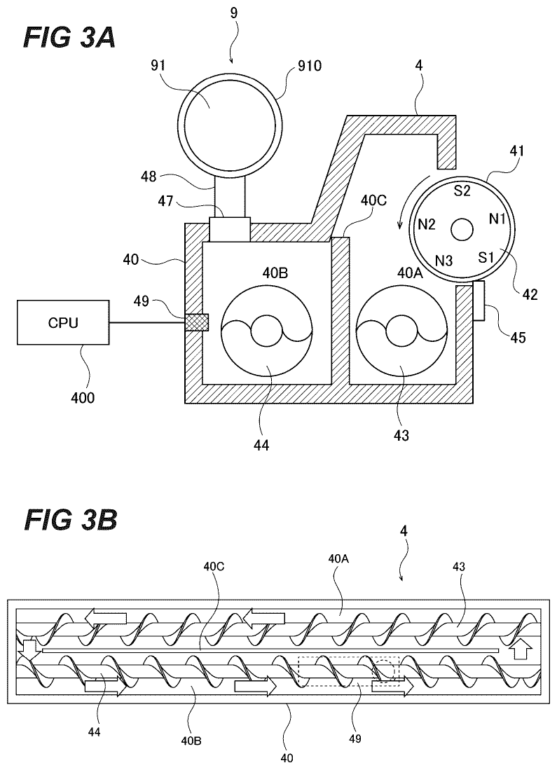

Next, the development device 4 will be described in detail with reference to FIG. 3A and FIG. 3B. FIG. 3A and FIG. 3B are a cross-sectional view and a top view of the development device 4, respectively.

The development device 4 includes a developing container 40 which is a developer accommodation portion that accommodates a two-component developer including a nonmagnetic toner and a magnetic carrier. Here, a mixing ratio of the two-component developer accommodated in the developing container 40 is approximately 1:9 in a weight ratio. In other words, a weight ratio of the nonmagnetic toner to the two-component developer accommodated in the developing container 40, that is, a toner density is approximately 10 wt %. The ratio should be appropriately adjusted depending on a charging amount of the toner, a carrier particle diameter, or a configuration and a use situation of the image forming apparatus, and does not necessarily have to follow this numerical value.

As the magnetic carrier, for example, metals such as iron, nickel, cobalt, manganese, chromium, and rare earths of which the surface is oxidized or unoxidized, alloys thereof, oxide ferrite, and the like can be suitably used, and a method for manufacturing these magnetic particles is not particularly limited. As the magnetic carrier of the present example, a material obtained by coating ferrite particles with a silicone resin is used. This magnetic carrier has a saturation magnetization of 294 am²/kg with respect to an applied magnetic field of 240 kA/m and a specific resistance of 1×10⁷ Ω·cm to 1×10⁸ Ω·cm at an electric field intensity of 3000 V/cm. In addition, the magnetic carrier may be a resin magnetic carrier manufactured by a polymerization method using a binder resin, a magnetic metal oxide, and a nonmagnetic metal oxide as starting materials.

A volume average particle diameter of the magnetic carrier is measured by dividing a particle diameter range of 0.5 μm to 350 μm by 32 logarithms on a volume basis, using a laser diffraction particle diameter distribution measuring device HEROS (manufactured by JEOL Ltd.), and the number of particles in each channel is measured. In addition, from the measurement result, the volume average particle diameter of the magnetic carrier is defined as a median diameter of 50% by volume. The volume average particle diameter of the magnetic carrier in the present example is 50 μm.

The nonmagnetic toner includes at least a binder, a colorant, and a charging control agent. In the present example, a styrene-acrylic resin is used as the binder resin, but a styrene-based resin, a polyester-based resin, or a polyethylene resin can also be used. In the present example, phthalocyanine blue is used as the colorant. However, as the colorant, various pigments and various dyes such as carbon black, chrome yellow, Hansa yellow, benzidine yellow, threne yellow, quinoline yellow, permanent orange GTR, pyrazolone orange, Vulcan orange, Watchung red, permanent red, brilliant carmine 3B, brilliant carmine 6B, Dupont oil red, pyrazolone red, lithol red, rhodamine B lake, lake red C, rose bengal, aniline blue, ultramarine blue, chalco oil blue, methylene blue chloride, phthalocyanine green, and malachite green oxalate may be used alone or in combination thereof.

As the charging control agent, a charging control agent for reinforcement may be contained as necessary. As the charging control agent for reinforcement, any known charging control agent can be used. Examples of the charging control agent include nigrosine-based dyes, triphenylmethane-based dyes, chromium-containing metal complex dyes, molybdic acid chelate pigments, rhodamine-based dyes, alkoxy-based amines, quaternary ammonium salts (including fluorine-modified quaternary ammonium salts), alkylamides, phosphorus elements alone or compounds thereof, tungsten elements alone or compounds thereof, fluorine-based activators, metal salicylic acid salts, and metal salts of salicylic acid derivatives.

Further, the nonmagnetic toner may include wax or an external additive. The wax is contained for improving toner parting properties from a fixing member at the time of fixing, and toner fixing properties. As the wax, a paraffin wax, a carnauba wax, a polyolefin, or the like can be used, and the wax is used by being kneaded and dispersed in a binder resin. In the present example, a resin obtained by kneading and dispersing a binder, a colorant, a charging control agent, and wax is pulverized by a mechanical pulverizer, and the pulverized resin is used.

Examples of the external additive particles include particles obtained by performing hydrophobic treatment on amorphous silica, and inorganic oxide fine particles such as titanium oxide and a titanium compound. It is preferable to control a powder flowability and a charging amount of the toner by externally adding these fine particles to the toner base material. The particle diameter of the external additive particle is desirably approximately 1 nm to 100 nm. In the present example, titanium oxide having an average particle diameter of 50 nm is externally added in a weight ratio of 0.5 wt %, and amorphous silica having an average particle diameter of 2 nm and amorphous silica having an average particle diameter of 100 nm are externally added in a weight ratio of 0.5 wt % and 1.0 wt %, respectively.

The particle diameter of the toner having the above configuration was measured using a powder particle diameter image analyzer FPIA-3000 manufactured by Sysmex Corporation, and the volume average particle diameter was 6.0 μm. In addition, the cohesion of the toner was measured by a powder tester manufactured by Hosokawa Micron Corporation, and was 30. In addition, the external-additive coverage rate of the toner was 60% when measured using ESCA.

### Method of Measuring Coverage Rate by ESCA

The external-additive coverage rate of the toner in the present example is calculated from an amount of silica-derived silicon (hereinafter, Si is omitted) atoms existing on the toner particle surface when measured by ESCA (X-ray photoelectron spectroscopy). ESCA is an analysis method of detecting atoms in a region of several nm or lower in a depth direction of a sample surface. Therefore, atoms on the toner surface can be detected. As a sample holder, a 75 mm square platen (provided with a screw hole having a diameter of approximately 1 mm for fixing the sample) attached to the apparatus was used. Since the screw hole of the platen is penetrated, the hole is filled with resin or the like to prepare a recess for powder measurement having a depth of approximately 0.5 mm. The measurement sample was packed into the recess with a spatula or the like, and was leveled off to prepare a sample.

The ESCA apparatus and the measurement conditions are as follows.
Apparatus used: PHI 5000 VersaProbe II manufactured by ULVAC-PHI, Inc.
Analysis method: narrow analysis
Measurement conditions:
X-ray source: Al-Kα
X-ray conditions: 100μ 25W 15 kV
Photoelectron capture angle: 45
Pass Energy: 58.70 eV
Measurement range: 300 μm×200 μm

The measurement was performed under the above conditions. In the analysis method, first, a peak derived from the C—C bond of the carbon 1s orbital is corrected to 285 eV. Thereafter, an amount of Si derived from silica with respect to the total amount of elements is calculated from a peak area derived from the silicon 2p orbital in which the peak top is detected at 100 eV or higher and 105 eV or lower by using a relative sensitivity factor provided by ULVAC-PHI. Next, the silica alone applied to the toner is measured by the same method as described above, an amount of Si derived from silica with respect to the total amount of elements is calculated, and a ratio of the amount of Si when the toner is measured to the amount of Si when the external additive alone is measured is set as a silica coverage rate in the present invention.

In the present example, 200 g of a developer D obtained by mixing the toner and the carrier at a mixing ratio (toner density) of 10 wt % is supplied into the development device.

In the development device 4, a development region facing the photosensitive drum 1 is opened, and a development sleeve 41 that is a developer bearing member is rotatably disposed so as to be partially exposed to the opening. The development sleeve 41 includes a fixed magnet roll 42 that is a magnetic field generation portion. The development sleeve 41 rotates in an arrow direction of FIG. 3A at the time of a development operation, holds the developer in the developing container 40 in a layer form, carries and conveys the developer to a development region facing the photosensitive drum 1, and develops the electrostatic latent image formed on the photosensitive drum 1 using a toner. The developer after developing the electrostatic latent image is conveyed according to the rotation of the development sleeve 41, and is collected in the developing container 40.

The developing container 40 is partitioned into a development chamber 40A and a stirring chamber 40B by a partition wall 40C, and constitutes a circulation path of the developer. In the developing container 40, a side close to the development sleeve 41 is the development chamber 40A, and a side far from the development sleeve 41 is the stirring chamber 40B. The development sleeve 41 carries and conveys the developer in the development chamber 40A. In the development chamber 40A of the developing container 40, a screw 43 (hereinafter, referred to as a “development screw”) that is a first conveying member is disposed. In the stirring chamber 40B of the developing container 40, a screw 44 (hereinafter, referred to as a “stirring screw”) that is a second conveying member is disposed. The developer in the developing container 40 is circularly conveyed in the developing container 40 while being mixed and stirred by the development screw 43 and the stirring screw 44. The direction of the developer circulation is a direction from the front side to the back side in FIG. 3A on the development screw 43 side, and is a direction from the back side to the front side on the stirring screw 44 side. In addition, the development screw 43 and the stirring screw 44 have a central axis diameter of 7 mm and an outer shape of 14 mm, and a rotation speed of each screw is 300 rpm. In addition, a distance between the developing container and each screw is set to 1 mm.

In the present example, the development sleeve 41 is arranged to face the photosensitive drum 1 with a gap of 300 μm, and is arranged to rotate in the same direction as the rotation direction of the photosensitive drum 1 (a direction of the arrow in FIG. 3A) and at 180% of the peripheral speed of the photosensitive drum 1. In addition, the development sleeve 41 is formed by molding a metal such as aluminum or SUS into a cylindrical shape and performing blasting treatment, plating treatment, or coating treatment on the metal surface to adjust the conveying property and the frictional charging imparting property of the developer. In the present example, a metal sleeve obtained by performing blast treatment on an aluminum surface is used.

In the development sleeve 41, the magnet roll 42 having a plurality of magnetic poles is fixedly disposed as a magnetic field generation portion. In the present example, the magnet roll 42 in which five magnetic poles are magnetized is used. An S1 pole is a developer amount regulating pole that regulates an amount of developer conveyed to the development region. An N1 pole is a development pole that contributes to development. An S2 pole is a conveyance pole that conveys the developer. An N2 pole is a repulsive pole that scrapes off the developer carried on the development sleeve. An N3 pole is an intake pole that causes the development sleeve 41 to carry the developer transferred from the development screw 43.

In the present example, the developer amount regulating member is disposed to face the development sleeve 41 across a flat-plate-type nonmagnetic blade 45 having a thickness of 1 mm with a constant uniform gap therebetween in the longitudinal direction. The shape of the nonmagnetic blade 45 is not limited to a flat plate type, and a tip shape of the nonmagnetic blade 45 may be sharpened to have a thickness of approximately 0.3 mm. According to the shape of the nonmagnetic blade 45, the distance between the development sleeve 41 and the nonmagnetic blade 45, and a size and an angle of the developer amount regulating magnetic pole S1, the developer carried on the development sleeve 41 is uniformly coated, and is conveyed to the development region. In the present example, an interval between the development sleeve 41 and the nonmagnetic blade 45 is set to 300 μm, and the mass per unit area (M/S) of the amount of the developer conveyed to the development region is regulated to 30 mg/cm².

With the above configuration, the developer in the development device 4 is carried by the development sleeve 41 including the magnet roll, and is conveyed to a position facing the photosensitive drum 1. Thus, a magnetic brush is formed at a position facing the photosensitive drum 1. Then, by applying a suitable development bias to the development sleeve 41, the electrostatic latent image on the photosensitive drum 1 is developed. In the present example, a voltage obtained by superimposing an AC component having a frequency of 10 kHz and a peak-to-peak voltage Vpp of 1.6 kV and a DC component (Vdc) of −450 V is applied from a high-voltage power supply 401, but the present invention is not limited to this numerical value.

In the present example, a magnetic permeability sensor is used as a toner density sensor (detection portion) 49 that detects the mixing ratio of the toner and the magnetic carrier in the developer in the development device. The magnetic permeability sensor measures a toner density by detecting a change in the apparent magnetic permeability of the developer (detecting inductance) that decreases as the toner density of the developer increases. In the present example, as illustrated in FIG. 3A, the toner density sensor 49 is disposed at a downstream position of the stirring chamber 40B and on a side surface of the development device 4. The toner density sensor 49 is preferably disposed such that sufficient developer always exists to detect a magnetic permeability. In addition, the position is determined such that the developer existing in the region detected by the magnetic permeability sensor is always subjected to the stirring action by the stirring screw 44. A detection value of the toner density sensor 49 is output to a CPU 400 that is a control portion.

In calculation of the toner density, a DC component of the output value of the magnetic permeability sensor is extracted by performing sampling on the output value of the magnetic permeability sensor at a plurality of points and then averaging values obtained by the sampling, and canceling a vibration component due to a rotation cycle of the stirring screw 44. Then, the toner density is calculated by referring to a table prepared by examining a relationship between the value and the toner density in advance.

In addition, a counter (not illustrated) using a video count scheme that is a consumed toner amount calculation portion of each image is also provided, and a level of an output signal of an image signal processing circuit (not illustrated) is counted for each pixel. Each pixel is integrated by the counter, and the video count number of each image is calculated. The video count number corresponds to an amount of toner consumed from the development device 4 to form one toner image of each image.

Based on the output of the toner density sensor 49 and the video count number, the CPU 400 determines a replenishment amount by a toner replenishment control method to be described later, and supplies a predetermined amount of toner to the development device 4 by a toner replenishment device 9 to be described later.

### Toner Replenishment Device

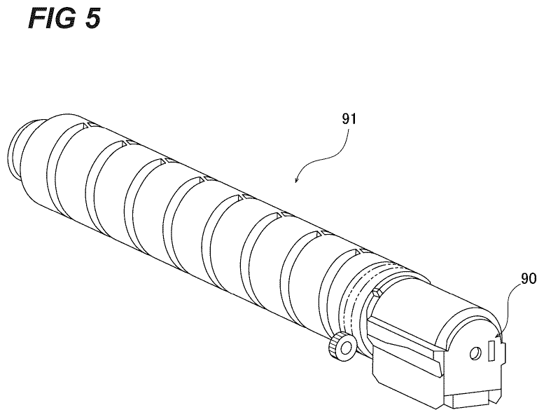

Next, a toner replenishment device 9 that is a toner replenishment portion in the present example will be described with reference to FIGS. 2, 3A, 3B, and 5. FIG. 5 is a perspective view of a developer replenishment container 91.

The developer replenishment container 91 illustrated in FIG. 5 can be easily attached to and detached from an attachment portion 910 of the image forming apparatus. In a case where the developer replenishment container 91 is attached to the attachment portion 910, a discharge port (not illustrated) of the developer replenishment container 91 communicates with a developer receiving port 47, and the developer discharged from the developer replenishment container 91 is supplied to the development device 4 through the developer receiving port 47. The developer sealed in the developer replenishment container 91 is a two-component developer in which a negatively-charged nonmagnetic toner and a magnetic carrier are mixed, and the same toner and carrier as those in the developer sealed in the development device 4 are used. Here, the developer sealed in the development device 4 is manufactured by mixing the toner and the carrier at a toner density of 10 wt %, whereas the developer sealed in the developer replenishment container 91 is manufactured by mixing the toner and the carrier at a carrier density of 9 wt %.

A storage portion (nonvolatile memory) is mounted for each color in the developer replenishment container 91 according to the present example. As the storage portion, an IC chip, a bar code, or the like can be used. The storage portion can be configured such that automatic reading by an information reading portion on the main body side can be performed. The toner memory 90 that is a storage portion in the present example is installed in front of the developer replenishment container 91, and can read and write data by the CPU 400 of the image forming apparatus. The image forming apparatus is provided with an information reading portion (not illustrated) that reads information in the toner memory 90, and is configured to perform communication with the toner memory 90 in a case where the developer replenishment container 91 is attached to the image forming apparatus.

The toner memory 90 stores information specific to the toner accommodated in each developer replenishment container 91. Examples of the specific information include the date of manufacture of the toner, the manufacture lot, and the characteristics of the external additive. In the present example, the specific information includes at least the external-additive coverage rate at the time of manufacture of the toner.

### Description of Ghost Image

The developer used in the present example is a dry two-component developer including a toner to which negative fine particles (external additives) having the same polarity as the charging polarity of the toner are added and a carrier. As described above, the external additive in the present example includes at least titanium oxide and amorphous silica (silica) in order to suitably control the powder flowability and the charging amount of the toner.

In a developing step of developing the developer according to the electrostatic latent image formed on the photosensitive drum 1, the toner of the developer carried on the development sleeve 41 in the development device 4 is mainly developed in an image portion (a bright-portion potential of the electrostatic latent image).

At this time, the external additive that is added to the toner and has a negative polarity, which is the same polarity as the charging polarity of the toner, is also simultaneously developed. In addition, since some of the external additives added to the toner are stirred in the development device, the adhesive force with the toner is reduced, and there are external additives that are separated from the toner.

These external additives have a negative polarity similarly to the toner, and are easily developed in the image portion. Thus, the amount of external additives developed in the image portion on the photosensitive drum 1 is larger than the amount of external additives developed in the non-image portion. The toner and the external additive developed on the photosensitive drum 1 are primarily transferred onto the intermediate transfer belt 51 in a transfer step. However, a part of the toner or the external additive having a particle diameter smaller than the particle diameter of the toner and having a large non-electrostatic adhesion force remains on the photosensitive drum 1 without being transferred to the intermediate transfer belt 51 in the transfer step.

After the transfer step, the transfer residual toner and the external additive that remain on the photosensitive drum 1 reach a cleaning step (the drum cleaner 6). The transfer residual toner remaining on the photosensitive drum 1 is cleaned by the cleaning blade 61. However, since the external additive has a particle diameter smaller than the particle diameter of the toner and has a large adhesion force with the photosensitive drum 1, the external additive cannot be cleaned and remains on the photosensitive drum 1 as it is.

After the cleaning process, the external additive remaining on the photosensitive drum 1 reaches a charging process (the charging roller 2). The external additive remaining on the photosensitive drum 1 forms an electric field in a direction of attracting the toner between the external additives attached to the photosensitive drum 1 due to the negative charging polarity of the fine particles themselves and the negative charges received by the charging voltage applied by the charging roller 2. In a case where the amount of the external additive attached to the photosensitive drum 1 increases, in the electric field formed in the direction of attracting the toner between the external additives, the force of attracting the toner also increases.

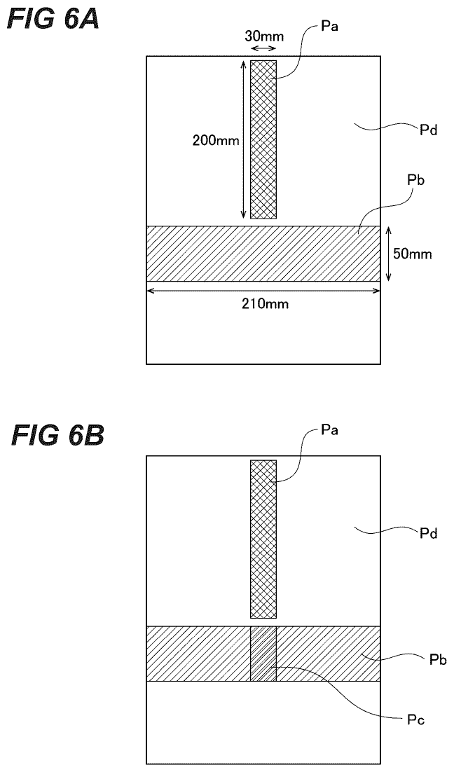

The difference in the amount of external additive attached to the photosensitive drum will be described with reference to FIGS. 6A and 6B. The image portions Pa and Pb illustrated in FIG. 6A are an image portion Pa having a main scanning width of 30 mm, a sub-scanning width of 200 mm, an image ratio of 100%, and a vertical band, and an image portion Pb having a main scanning width of 210 mm, a sub-scanning width of 50 mm, an image ratio of 30%, and a horizontal band on a downstream side of the vertical band. In this image portion, since a large amount of external additive is supplied onto the photosensitive drum together with the toner, the amount of external additive remaining on the photosensitive drum increases. On the other hand, since a toner image is not formed in the non-image portion Pd, no toner is supplied, and the amount of external additives attached is small.

In a case where a difference in the amount of the external additive attached to the photosensitive drum between the image portion and the non-image portion increases in this manner, there is also a difference in the force of attracting the toner from a portion of the photosensitive drum to which the external additive is attached. Therefore, in the image portion on the photosensitive drum, the electric field formed by the external additive at the time of the next image formation is stronger than that in the non-image portion, and the toner is more easily attracted. In addition, in a case where the same or similar image patterns are continuously formed, these steps are continuously performed. Thus, the accumulation amount of the external additive increases in the image portion on the photosensitive drum 1. In this case, in a portion at which the accumulation amount of the external additive on the photosensitive drum increases, the force of attracting the toner becomes stronger, and the development amount of the toner further increases. As a result, in a case where a uniform image such as a halftone image is formed, a density difference occurs between the image portion and the non-image portion, and the image is recognized as a ghost image.

For example, in a case where the image portion Pa having the vertical band and the image portion Pb having the horizontal band that are illustrated in FIG. 6A are continuously formed, the image portion Pb having a tone lower than the tone of the image portion Pa on the downstream side of the image portion Pa, in a portion Pc at which the image portion Pb and the image portion Pa on the photosensitive drum overlap with each other, as compared with other portions, the accumulation amount of the external additive increases. Therefore, in the overlapping portion Pc on the photosensitive drum, the force of attracting the toner is stronger than that in other portions, and the development amount of the toner is increased. As a result, the overlapping portion Pc is visually recognized as a ghost image (overlapping portion Pc) as illustrated in FIG. 6B.

As described above, the occurrence of the ghost image is caused by the large development amount of the toner due to the difference in the accumulation amount of the external additive remaining on the photosensitive drum. As a result, since the developer in which a ratio of the external additive is high is frequently supplied into the development device, the density of the external additive of the developer in the development device excessively increases, and a large amount of the external additive is developed together with the toner. Thus, a risk of occurrence of a ghost image described above increases. That is, the risk of occurrence of a ghost image increases as the amount of external additive in the toner increases. As described above, the amount of the external additive in the toner is defined by the external-additive silica coverage rate of the toner using ESCA measurement, and in the present example, the silica coverage rate of the toner alone at the center of mass production variation is 60%.

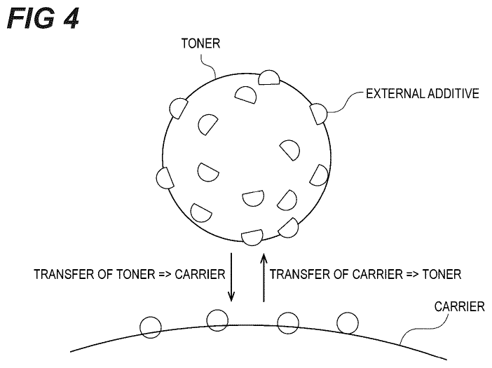

Here, as illustrated in FIG. 4, in the two-component developer including the toner and the carrier, the external additive carried on the toner surface is transferred to the carrier by the contact between the toner and the carrier, and the total amount of the external additive is shared between the entire toner and the entire carrier. Thus, a certain equilibrium relationship is established. For example, in a case where the external-additive coverage rate of the toner alone is 60%, when the toner density in the developer including the toner and the carrier is 10%, the external-additive coverage rate of the toner in the development device is 58%. That is, the result indicates that 2% of the external-additive coverage rate of the toner alone of 60% has transferred to the carrier surface.

In the present example, in a case where the external-additive coverage rate of the toner in the developer in the development device becomes 61%, the amount of the external additive attached to the photosensitive drum becomes excessive, and a ghost image becomes apparent. That is, at the center of mass production variation (in a case where the external-additive coverage rate does not exceed a threshold value), the external-additive coverage rate of the toner in the developer in the development device is 58%, and thus, a ghost image does not occur.

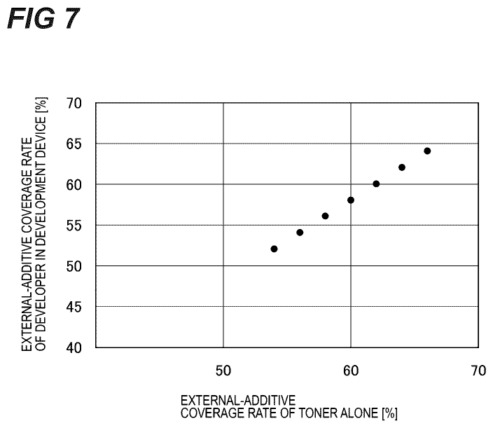

However, in the toner manufacturing process, the external-additive coverage rate of the toner alone varies depending on variations in the manufacturing conditions. Specifically, the external-additive coverage rate of the toner alone varies from 56% to 64%. As a result, from FIG. 7, in the developer having a toner density of 10%, the external-additive coverage rate of the toner in the developer in the development device varies from 54% to 62%. In a case where the external-additive coverage rate of the toner in the developer in the development device exceeds 61%, which is a threshold value of the external-additive coverage rate at which a ghost image occurs, the image may become apparent as an abnormal image.

### Toner Density Control

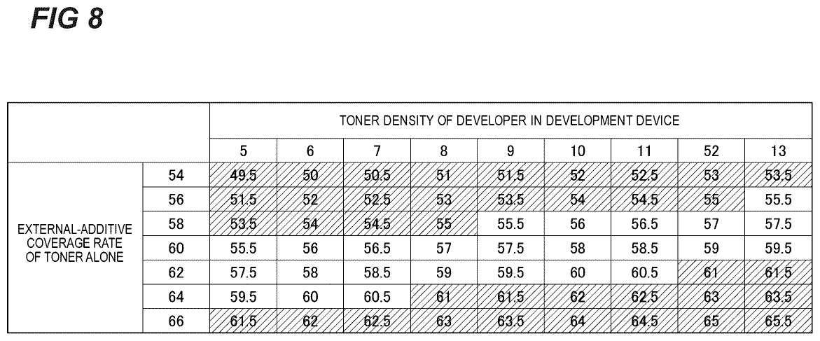

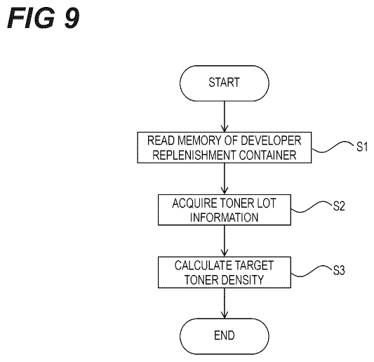

The toner density control in the present example will be described with reference to FIGS. 2, 8, and 9. FIG. 2 is a block diagram illustrating a control system of the image forming apparatus 100 and the development device 4. FIG. 8 is a table illustrating a relationship between the external-additive coverage rate of the toner alone and the external-additive coverage rate of the toner in the developer in the development device for each toner density. FIG. 9 is a flowchart illustrating a toner density calculation method in the present example.

As illustrated in FIG. 2, the CPU 400 includes a toner density control portion 410 and a toner density calculation portion 420. The CPU 400 is connected to the toner density sensor 49 that is a detection portion provided in the development device 4 and the toner memory 90 that is a storage portion provided in the developer replenishment container 91.

The toner density calculation portion 420 calculates an output related to the toner density obtained by the toner density sensor 49 of the development device 4. Further, the toner density control portion 410 calculates (sets) a target toner density during an operation of the image forming apparatus from the information related to the external additive of the toner alone, the information being stored in the toner memory 90 of the developer replenishment container 91.

In the present example, the external-additive coverage rate of the toner alone is measured in advance for each lot at the toner manufacturing stage, and data related to the external-additive coverage rate of the toner, which is accommodated when filling the developer replenishment container 91 with the toner, is stored in the toner memory 90. Thereby, the external-additive coverage rate of the toner is measured for each toner manufacture lot, and the same coverage rate is stored in the toner memory 90 of the developer replenishment container 91 filled with the toner of the same manufacture lot.

From the information that is related to the external-additive coverage rate of the toner and is stored in the toner memory 90 of the developer replenishment container 91, it is possible to estimate a value of the external-additive coverage rate of the toner in the developer to be supplied to the development device 4. Therefore, it can be determined whether or not a ghost image occurs due to variation for each toner manufacture lot, and occurrence of a ghost image can be prevented by performing toner density control of setting the toner density of the developer of the development device 4 based on the information stored in the toner memory 90.

Here, the CPU 400 includes a table illustrating a relationship between the external-additive coverage rate of the toner alone and the external-additive coverage rate of the toner in the developer in the development device for each toner density as illustrated in FIG. 8. Then, the CPU 400 sets the toner density of the developer in the development device 4 from the table based on the information stored in the toner memory 90 by the toner density control to be described below.

The toner density control that is a countermeasure against the ghost image will be described. In the two-component developer including the toner and the carrier, in a case where the toner density is low with respect to a certain amount of carrier, that is, in a case where the number of toners is small, the carrier amount relatively increases with respect to the toner. Therefore, in a case where the external additive is shared between the toner and the carrier, when the equilibrium state is reached, the amount of the external additive carried by the carrier increases, and conversely, the external additive carried by the toner decreases.

As illustrated in FIG. 8, for example, there is a case where the external-additive coverage rate of the toner alone is 64%, in other words, a case where the external-additive coverage rate stored in the toner memory 90 of the developer replenishment container 91 is 64%. In a case where the external-additive coverage rate of the toner alone is 64%, when the toner density of the developer in the development device 4 is 10%, the external-additive coverage rate of the toner in the developer in the development device 4 is 62%, and exceeds 61% which is a threshold value at which a ghost image occurs. However, even in a case where the external-additive coverage rate of the toner alone is 64%, when the toner density of the developer in the development device 4 is lowered to 7%, the external-additive coverage rate of the toner in the developer in the development device 4 becomes 60.5%, and thus, the occurrence of a ghost image can be prevented.

A flow of the toner density control according to the present example will be described with reference to FIG. 9. The CPU 400 reads information stored in the toner memory 90 of the developer replenishment container 91 by an information reading portion (not illustrated) on the image forming apparatus side (step S1), and acquires toner lot information that is information specific to the toner (step S2). Thereby, information related to the external-additive coverage rate of the toner alone that is accommodated in the developer replenishment container 91 is obtained. The CPU 400 sets, as a target toner density, the toner density of the developer in the development device 4 based on the information related to the external-additive coverage rate of the toner alone that is accommodated in the developer replenishment container 91 (step S3). That is, the CPU 400 sets, as the toner density of the developer in the development device 4, the toner density at which the external-additive coverage rate of the toner in the developer in the development device 4 is lower than a first threshold value based on the information stored in the toner memory 90. Here, the first threshold value of the external-additive coverage rate of the toner in the developer in the development device 4 is a threshold value (61% in FIG. 8) at which a ghost image occurs.

As described above, the information related to the external-additive coverage rate of the toner depending on the lot variation in the toner manufacturing process is stored in the toner memory 90 of the developer replenishment container 91, and in a case where it is determined that the external-additive coverage rate of the toner is large from a result obtained by reading the stored information, the target toner density is lowered. Thereby, it is possible to prevent the occurrence of a ghost image.

### Example 2

Next, an image forming apparatus according to the present example will be described. Note that the schematic configuration of the image forming apparatus according to the present example is similar to the configuration of the above-described example, and thus description thereof is omitted here.

In the example described above, in order to prevent the occurrence of a ghost image, the toner density of the developer in the development device 4 is set to the toner density at which the external-additive coverage rate of the toner in the developer in the development device 4 is lower than the first threshold value based on the external-additive coverage rate of the toner that is stored in the toner memory 90.

Thereby, even in a case where the external-additive coverage rate of the toner decreases due to the variation in the external-additive coverage rate of the toner for each manufacture lot, it is possible to form a suitable image by feeding back the information stored in the toner memory 90 of the developer replenishment container 91 to the toner density control.

On the other hand, in the present example, the toner density of the developer in the development device 4 is set to a toner density at which the external-additive coverage rate of the toner in the developer in the development device 4 exceeds a second threshold value smaller than the first threshold value based on the external-additive coverage rate of the toner that is stored in the toner memory 90. Hereinafter, description will be made.

First, in a case where an external additive having a small particle diameter is carried on the toner surface, a contact area between the toner and the carrier can be reduced, and the adhesion force between the toner and the carrier can be reduced. Thereby, it is possible to increase a flying property of causing the toner of the developer on the development sleeve 41 to fly to the photosensitive drum 1.

However, in a case where the external-additive coverage rate of the toner is low, since the amount of the external additive carried on the toner surface is small, the contact area between the toner and the carrier increases, and the adhesion force between the toner and the carrier increases. Thereby, the toner of the developer on the development sleeve 41 cannot be sufficiently flown to the photosensitive drum 1, and the density of the output image is decreased (a decrease in density).

The external-additive coverage rate of the toner in the developer in the development device 4 when a decrease in density occurs is a second threshold value (55% in FIG. 8) smaller than the first threshold value described above.

In the toner manufacturing process, the external-additive coverage rate of the toner alone varies depending on variations in manufacturing conditions. Specifically, the external-additive coverage rate of the toner alone varies from 56% to 64%. As a result, from FIG. 7, in the developer having a toner density of 10%, the external-additive coverage rate of the toner in the developer in the development device 4 varies from 54% to 62%. In a case where the external-additive coverage rate of the toner in the developer in the development device is lower than 55%, which is a threshold value (second threshold value) of the external-additive coverage rate at which a decrease in density occurs, the image may become apparent as an abnormal image.

As illustrated in FIG. 8, for example, there is a case where the external-additive coverage rate of the toner alone is 56%, in other words, a case where the external-additive coverage rate stored in the toner memory 90 of the developer replenishment container 91 is 56%. In a case where the external-additive coverage rate of the toner alone is 56%, when the toner density of the developer in the development device 4 is 10%, the external-additive coverage rate of the toner in the developer in the development device 4 is 54%, which is lower than 55% that is a second threshold value at which a decrease in density occurs. However, even in a case where the external-additive coverage rate of the toner alone is 56%, when the toner density of the developer in the development device 4 is increased to 13%, the external-additive coverage rate of the developer in the development device 4 becomes 55.5%, and thus, the occurrence of a decrease in density can be prevented.

As described above, the information related to the external-additive coverage rate of the toner depending on the lot variation in the toner manufacturing process is stored in the toner memory 90 of the developer replenishment container 91, and in a case where it is determined that the external-additive coverage rate of the toner is small from a result obtained by reading the stored information, the target toner density is increased. Thereby, it is possible to prevent the occurrence of a decrease in density.

### Other Examples

In the example described above, the information related to the external-additive coverage rate of the toner depending on the lot variation in the toner manufacturing process is stored in the toner memory 90 of the developer replenishment container 91, and the stored information is read to be fed back to the toner density control. However, the information related to the external additive that is stored in the toner memory 90 of the developer replenishment container 91 is not limited to the external-additive coverage rate. For example, the information may be information related to the adhesion state of the external additive (fine particles) to the toner, such as a characteristic value indicating adhesion of the external additive to the toner surface, such as strength for fixing the external additive to the toner surface and ease of transfer of the external additive carried on the toner surface to the carrier.

In the example described above, four image forming portions are used, but the number of the image forming portions used is not limited, and may be appropriately set as necessary.

Further, in the above-described example, the laser scanner is used as the exposure portion, but the exposure portion is not limited thereto. For example, an optical print head (exposure head) including a substrate on which a plurality of light emitting elements is mounted and a lens array may be used.

Further, in the above-described example, the printer has been exemplified as the image forming apparatus, but the present invention is not limited thereto. For example, another image forming apparatus such as a copying machine or a facsimile machine, or another image forming apparatus such as a multifunction machine configured by combining the functions of these machines. The image forming apparatus has been exemplified in which an intermediate transfer member is used, toner images of each color are transferred onto the intermediate transfer member in a sequentially superimposed manner, and the toner images carried on the intermediate transfer member are collectively transferred onto a transfer material, but the present invention is not limited thereto. For example, the image forming apparatus may also be an image forming apparatus that uses a transfer material bearing member and transfers toner images of each color onto the transfer material carried on the transfer material bearing member in a sequentially superimposed manner. Similar effects can be obtained by applying the present invention to these image forming apparatuses.

According to the present invention, it is possible to provide an image forming apparatus capable of forming a good image even in a case where the amount of the external additive carried on the toner surface varies depending on the lot when manufacturing the toner.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-115586, filed Jul. 19, 2024, which is hereby incorporated by reference herein in its entirety.

What is claimed is:

1. An image forming apparatus comprising:
an image bearing member;
a development device configured to include a developer accommodation portion configured to accommodate a developer including a toner and a carrier, and a developer bearing member configured to carry and convey the developer, and develop an electrostatic image formed on the image bearing member using the toner;
a detection portion configured to detect a toner density of the developer accommodated in the developer accommodation portion;
a developer replenishment container configured to be detachably attached to the image forming apparatus, accommodate the developer including the toner having a fine particle attached to a surface of the toner, and replenish the developer to the developer accommodation portion;
a storage portion configured to be provided in the developer replenishment container, and store information specific to the toner accommodated in the developer replenishment container; and
a control portion configured to set a target toner density of the developer based on the information stored in the storage portion and then control the toner density of the developer accommodated in the developer accommodation portion based on a result detected by the detection portion so that the toner density of the developer accommodated in the developer accommodation portion is the target toner density of the developer.

2. The image forming apparatus according to claim 1, wherein the storage portion is configured to store, as the information, information related to an adhesion state of the fine particle to the toner.

3. The image forming apparatus according to claim 1, wherein the storage portion is configured to store, as the information, information related to a fine-particle coverage rate of the toner.

4. The image forming apparatus according to claim 1, wherein the control portion is configured to acquire a fine-particle coverage rate of the toner accommodated in the developer replenishment container from the information stored in the storage portion, and set the target toner density of the developer based on the fine-particle coverage rate of the toner.

5. The image forming apparatus according to claim 1, wherein the control portion is configured to acquire the fine-particle coverage rate of the toner accommodated in the developer replenishment container from the information stored in the storage portion, and set the target toner density of the developer to a toner density at which the fine-particle coverage rate of the developer accommodated in the developer accommodation portion is lower than 61% based on the acquired fine-particle coverage rate of the toner.

6. The image forming apparatus according to claim 5, wherein the control portion is configured to acquire the fine-particle coverage rate of the toner accommodated in the developer replenishment container from the information stored in the storage portion, and set the target toner density of the developer to a toner density at which the fine-particle coverage rate of the developer accommodated in the developer accommodation portion is higher than 55% and smaller than 61% based on the acquired fine-particle coverage rate of the toner.

7. The image forming apparatus according to claim 1, wherein the control portion is configured to store a table representing a relationship between an external-additive coverage rate of the toner for each toner density and an external-additive coverage rate of the toner in the developer accommodated in the developer accommodation portion, and set the target toner density of the developer from the table based on the information stored in the storage portion.
